(19) United States
(12) Patent Application Publication
(10) Pub. No.: US 2012/0124776 A1
(43) Pub. Date: May 24, 2012

(54) ADJUSTABLE DOOR STOP WITH HINGE PIN

(75) Inventor: Joseph McDonnell, Weston, FL (US)

(73) Assignee: FOR LIFE PRODUCTS, INC., Miramar, FL (US)

(21) Appl. No.: 13/226,968

(22) Filed: Sep. 7, 2011

Related U.S. Application Data
(60) Provisional application No. 61/415,226, filed on Nov. 18, 2010.

(51) Int. Cl. E05D 11/06

(52) U.S. Cl. 16/375

(57) ABSTRACT

An adjustable door stop for a hinge mounted door having at least one hinge leaf connected to the door and a hinge pin passing through the hinge, the adjustable door stop having a first door stop member with a top portion and a first leg extending from the top and a second door stop member with a second leg extending from the second adjustment portion in a direction parallel to the axis of the hinge pin to engage the hinge leaf and limit door swing. A hinge pin including a shaft including an expanded portion having a diameter smaller than a head of the hinge pin and a portion of the diameter greater than the hole in the hinge leaf. The first door stop member and the second door stop member are relatively positionable to one another.

### CROSS REFERENCE TO RELATED APPLICATIONS

This application claims the benefit of U.S. Provisional Application No. 61/415,226 filed on Nov. 18, 2010.

### FIELD

This application relates generally to door stops and is more particularly directed to an adjustable door stop that may be positioned to control the range of motion associated with the opening and closing of a door within a range of up to 360 degrees and/or the maximum movable range of a door hinge.

### BACKGROUND

Door stops are known to take on a variety of configurations such as heavy floor-type stops that are simply placed in front of an open door to hold the door in a desired position and wedge-type stops placed between the floor and a bottom edge of the door. Although such stops have been known for many years and successfully hold the door in place, there is a disadvantage in that floor-type and wedge-type stops must be moved to close the door and reset when the door is again opened. Moreover, such door stops are only useful in retaining an open door in place and therefore have a disadvantage in that they do not prevent a door from opening too far and potentially damaging an adjoining wall or other item within the swing of the door. Another floor-type stop is affixed to the floor at a position to stop door swing at a particular place. However, such stops damage the floor due to the use of fasteners, such as screws, required to hold the door stop in place. Such floor-type stops may also become a trip point hazard.

Other door stops are known which prevent a door from opening too far. For example, wall-type stops that are affixed to a wall or baseboard may be used to limit door swing and thereby prevent damage to an adjoining wall or other item. However, these door stops have very limited, if any, adjustment to vary a maximum and/or minimum amount of door swing. Wall-type stops also have the further disadvantage of damaging the wall or baseboard they are attached to due to fasteners, such as screws, required to hold the stop in place.

Hinge-type stops are less intrusive and potentially damaging then either floor-type or wall-type door stops. Hinge-type stops are held in place by receiving, a hinge pin through a hole in a body of the door stop and usually have a threaded rod allowing for adjustability. One end of the arm is directed toward the door and another end is directed toward the wall or door casing. As the door opens, the arm will encounter the door and the wall or casing to limit the door swing according to the adjustment of the threaded rod.

### SUMMARY

In an example embodiment, the adjustable door stop includes two primary components. The first component has a male portion that has one or a plurality of detents positioned at intervals around the exterior of a wall forming a central hole. The detents may be disposed at 45 degrees, or at larger or smaller angular relationships about the central hole. The second component has a female receptacle for receiving the male portion of the first component such that the detents are engaged in corresponding apertures along the interior of the central hole that restricts relative movement of the components. For example, each of the detents engage corresponding indented portions in the second component for restricting rotational movement of the two components with respect to one another. Additional components, such as a custom hinge pin, may comprise the adjustable door stop.

As shown in the accompanying figures, the two primary components once fit together are positioned on a door hinge by removing the original hinge pin, placing the two components (positioned together) on the top or bottom portion of the hinge and inserting a custom hinge pin through the corresponding holes into the assembled components. The lengths of two extended portions of the respective primary components engage respective sides of the hinge. Very simply, the components can be used by merely removing a hinge pin from a hinge, positioning the unit and re-engaging a hinge pin within the door stop and the hinge.

While the door stop is preferably made of light weight metal such as carbon steel, stainless steel, aluminum, alloys thereof or other material sufficiently resilient to withstand the rotational forces associated with the opening and closing of a door. Additional features and attributes of the door stop are readily apparent to one of ordinary skill in the art from the accompanying drawings.

### BRIEF DESCRIPTION OF THE DRAWINGS

Various aspects of the teachings of embodiments of the present invention, and arrangements embodying those teachings, will hereafter be described by way of illustrative.

FIG. 1 is a perspective view of an example embodiment of a male portion of the adjustable door stop;

FIG. 2 is a perspective view of an example embodiment of a female portion of the adjustable door stop;

FIG. 3 is a perspective view of an example embodiment of the adjustable door stop including the members shown in FIGS. 1 and 2;

FIG. 4 is a bottom view of the adjustable door stop of FIG. 3;

FIG. 5 is a top view of the adjustable door stop of FIG. 3;

FIG. 6 shows an example embodiment of a hinge pin useful in the adjustable door stop;

FIG. 7 shows an example embodiment of the adjustable door stop on a hinge;

FIG. 8 shows an example embodiment of the adjustable door stop on a hinge;

FIG. 9 shows an example embodiment of an adjustable door stop mounted on a hinge;

FIG. 10 shows a variety of stopped door positions in accordance with an example embodiment of the adjustable door stop;

FIG. 11 is a perspective view of an example embodiment of a first member of the adjustable door stop;

FIG. 12 is a perspective view of an example embodiment of a second member of the adjustable door stop;

FIG. 13 shows an example embodiment of a hinge pin useful in the adjustable door stop;

FIG. 14 shows an exploded view of an embodiment of the adjustable door stop and an example embodiment of a hinge pin with a hinge; and

FIG. 15 shows an example embodiment of an adjustable door stop and hinge pin mounted on a hinge.

The accompanying drawings are provided to assist in the understanding of the exemplary embodiments of the invention as described in more detail below and should not be construed as unduly limiting the invention. In particular, the relative spacing, positioning, sizing and dimensions of the various elements illustrated in the drawings are not necessarily drawn to scale and may have been exaggerated, reduced or otherwise modified for the purpose of improved understanding and clarity.

Those of ordinary skill in the art will also appreciate that a range of alternative configurations have been omitted simply to improve the clarity and reduce the number of drawings. Those of ordinary skill will appreciate that certain of the various process steps illustrated or described with respect to the exemplary embodiments may be selectively and independently combined to create other methods useful for manufacturing an adjustable door stop without departing from the scope and spirit of this disclosure.

### DETAILED DESCRIPTION OF EXAMPLE EMBODIMENTS

Referring now to the drawings in which like reference numerals designate like or corresponding parts throughout the several views, there is shown an example embodiments of an adjustable door stop and hinge pin, shown for the purpose of illustration. One skilled in the art will readily recognize from the following description, taken in conjunction with the accompanying drawings and claims, that the principles of the subject matter of the present application may be applicable to other embodiments other than that shown for purposes of illustration in the drawings.

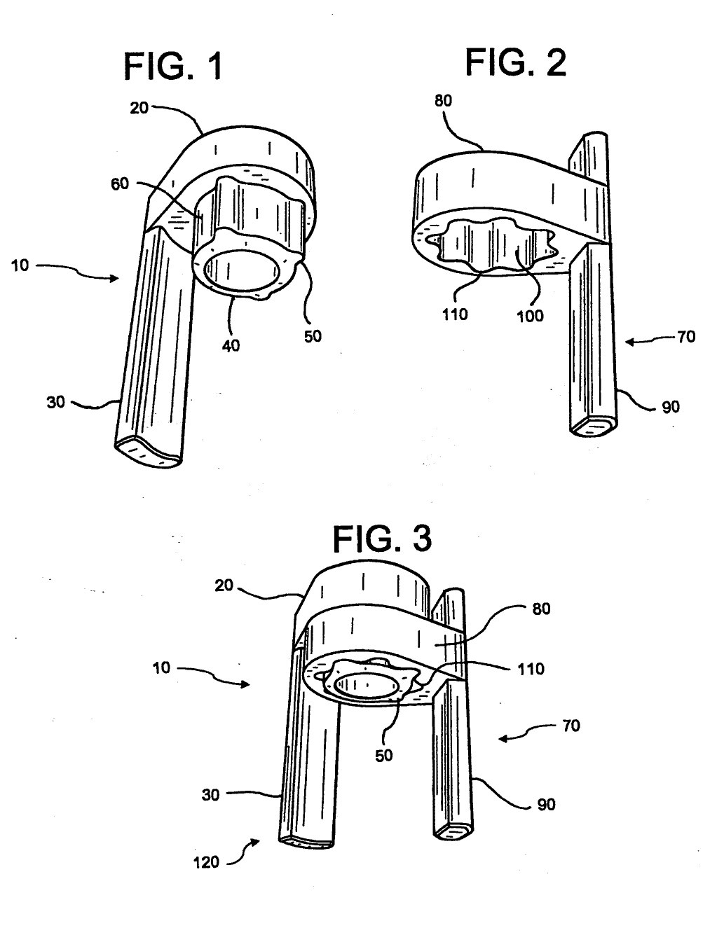

As shown in FIG. 1, a first door stop member 10 includes a top portion 20 and a first leg 30 extending from the top portion 20 at essentially a right angle. In one embodiment, a male portion 40 extends from the top portion 20 in the same direction as the first leg 30 and includes at least one detent 50 extending from the periphery of a wall 60 of the male portion 40. The detents 50 may be disposed at 45 degree intervals, or at larger or smaller angular relationships about the hole. In other embodiments, the male portion 40 and the first leg 30 may extend in opposing directions. A hole formed in part by the wall 60 passes through the male portion 40 and the top portion 20. The hole provides passage through the first door stop member 10 for a hinge pin as will be discussed in greater detail below. The component parts of the first door stop member 10 (top portion 20, the first leg 30, male portion 40) may be integrally formed from a single element by machining, casting, or the like, or formed of separate components and joined together by welding, brazing, gluing, or the like. In example embodiments, the component parts may be case hardened by heat treatment methods or cast using powdered metallurgy methods.

As shown in FIG. 2, a second door stop member 70 includes a female portion 80 and a second leg 90 extending from the female portion 80 at essentially a right angle. The female portion 80 includes a hole formed by an interior side wall 100 that provides passage through the second door stop member 70 for a hinge pin as will be discussed in greater detail below. The interior side wall 100 includes a plurality of apertures 110 formed therein. The apertures 110 provide stop positions for the adjustable door stop 120 as will be discussed in greater detail below. The component parts of the second door stop member 70 (the female portion 80, the second leg 90) may be integrally formed from a single element by machining, casting, or the like, or formed of separate components and joined together by welding, brazing, gluing, or the like. In example embodiments, the component parts may be case hardened by heat treatment methods or cast using powdered metallurgy methods.

FIG. 3 shows an adjustable door stop 120 comprised of the first door stop member 10 and the second door stop member 70. As shown in FIG. 3, the male portion 40 of the first door stop member 10 is received in the female portion 80 of the second door stop member 70 such that the female portion 80 abuts against the top portion 20. As will be readily apparent to those of skill in the art, the adjustable door stop 120 is adjustable by varying the relative positioning of the first and second door stop members 10, 70 according to an alignment of the detents 50 on the male portion 40 with the apertures 110 of the female portion 80. When assembled, the first leg 30 and the second leg 90 are coextensive. By varying the relative positioning of the first and second door stop members 10, 70, the adjustable door stop 120 may be positioned to control the range of motion associated with the opening and closing of a door within a range of up to 360 degrees and/or the maximum movable range of a door hinge.

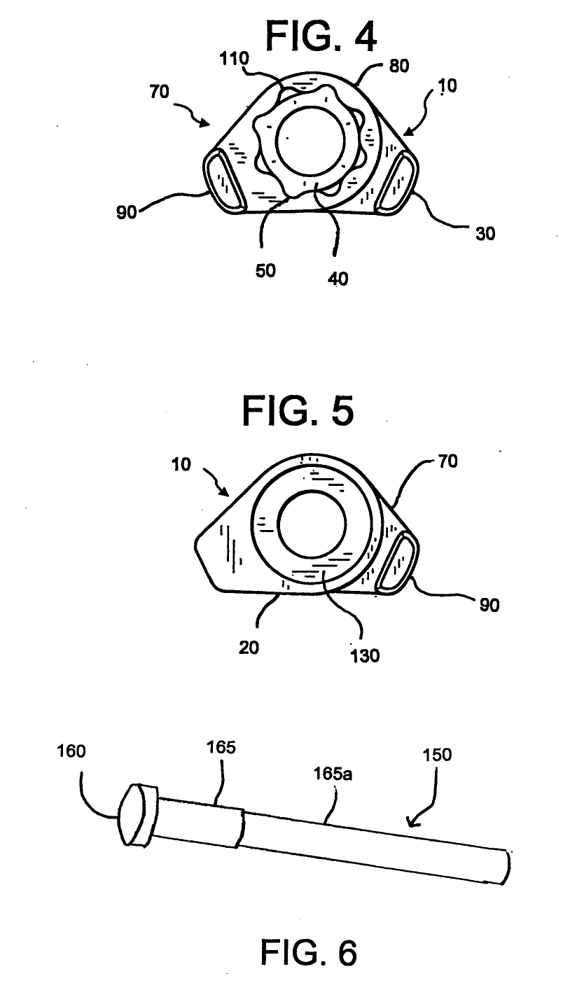

FIG. 4 shows a first end view of the adjustable door stop 120 further illustrating the interrelationship between the detents 50 in the male portion 40 of the first door stop member 10 and the apertures 110 of the female portion 80 of the second door stop member 70. As will be apparent to one of skill in the art, by separating and rotating the first door stop member and the second door stop member 70 relative to one another, the spacing between the first leg 30 and the second leg 90 may be adjusted about an axis formed by a hinge pin passing through the hole formed by the wall 60 of the first door stop member 10 and the side wall 100 of the second door stop member 70.

FIG. 5 is a second end view of the adjustable door stop 120 from an insertion direction of a hinge pin through the adjustable door stop 120. As shown in FIG. 5, the first door stop member 10 includes a recess 130 formed in the top portion 20. In an example embodiment, upon insertion of a hinge pin through the adjustable door stop 120, a portion of a head of the hinge pin may be disposed within the recess 130. As shown in FIG. 5, the recess 130 is larger than the hole formed through the top portion 20 and the male portion 40 to receive a hinge pin.

FIG. 6 shows an example embodiment of a modified hinge pin for use in the adjustable door stop 120. As shown in FIG. 6, the modified hinge pin 150 includes a head 160, a shaft portion 165a, and an expanded shaft portion 165 having a diameter greater than that of the shaft portion 165a. In the illustrated embodiment, the expanded portion 165 is located directly adjacent to and/or abutting the head 160. The modified hinge pin 150 may also have a length greater than a conventional hinge pin and/or greater than the original hinge pin of the hinge in which the adjustable door stop 120 is to be placed. In an example embodiment, the length of the modified hinge pin 150 is substantially equal to a conventional hinge pin plus the thickness of the top portion 20 and the female portion 80 (thickness being considered as the dimension in the axial direction of the hinge pin).

In an example embodiment of the modified hinge pin 150, the expanded shaft portion 165 provides a tight fit in the adjustable door stop 120 and/or in a hinge in which the adjustable door stop 120 is to be placed thereby deterring creep or lift of the modified hinge pin 150 out of the adjustable door stop 120 and/or hinge. Also, by having a shaft portion 165 of greater length than a conventional hinge pin, the hinge plates may be more securely maintained in their respective positions because the modified hinge pin will engage the entire length of the hinge. In contrast, if a conventional or original hinge pin were engaged with the adjustable door stop 120 and reinserted in a hinge, it is possible that the shaft of the original hinge pin would not extend through the entire length of the hinge plates due to the dimensions of the thickness of the first door stop member 10 and the second door stop member 70.

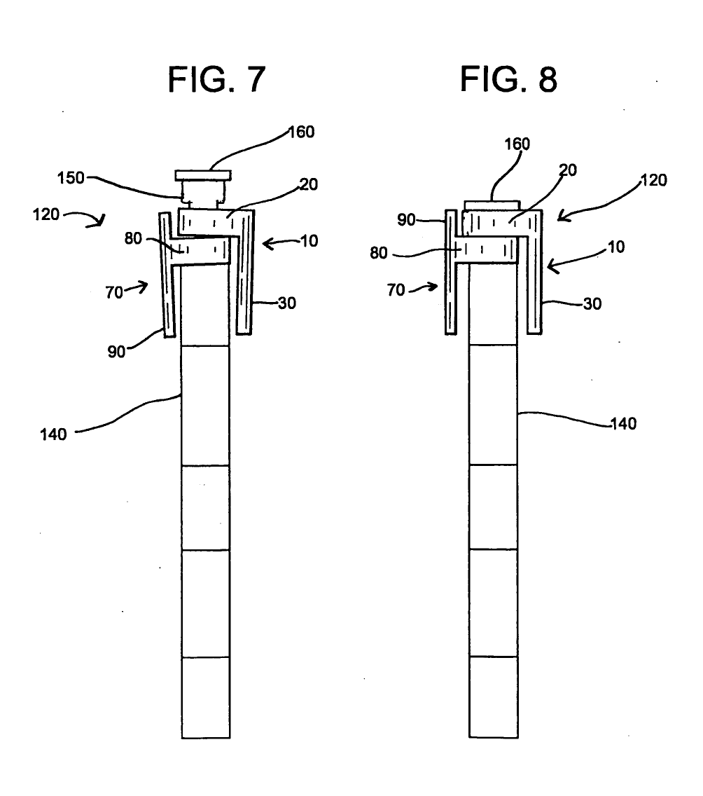

FIG. 7 shows an example embodiment of the adjustable door stop 120 on a hinge 140 with a modified hinge pin 150 partially inserted in the adjustable door stop 120. In an exemplary embodiment of the adjustable door stop 120, once the first door stop member 10 and the second door stop member 70 are positioned in a desired position on a conventional door hinge 140 by removing the hinge pin, the two primary components (positioned together) are placed on the top or bottom portion of the hinge 140 and inserting the modified hinge pin 150 through the corresponding holes in the assembled components. The two legs 30, 90 may engage respective sides of the hinge 140. As shown in FIG. 5, top portion 20 of the first door stop member 10 has a recess 130 formed therein allowing a head 160 of the modified hinge pin 150 to be positioned in the adjustable door stop 120. Thus, the adjustable door stop 120 may be used by merely removing the original hinge pin from a hinge 140, positioning the adjustable door stop 120 and re-engaging the modified pin 150 through the adjustable door stop 120 and into the hinge 140.

FIG. 8 shows an example embodiment of the adjustable door stop 120 on the hinge 140 with the modified hinge pin 150 in a fully inserted position. In an example embodiment, the head 160 of the modified hinge pin 150 may be disposed partially within the recess 130 of the top portion 20 or completely within the recess 130. In an exemplary embodiment, it is possible that the head 160 of the modified hinge pin 150 is not disposed in the recess 130.

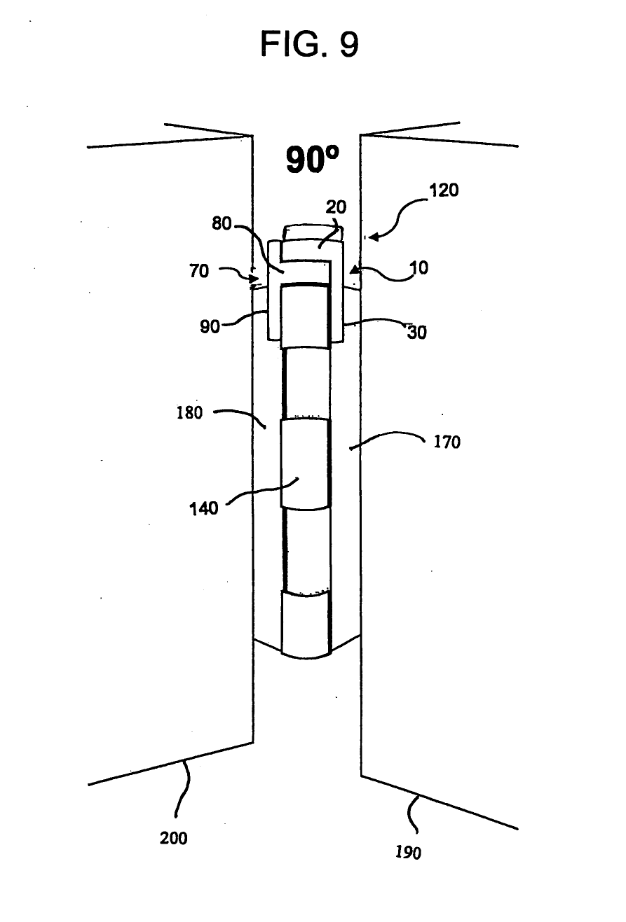

FIG. 9 shows an example embodiment of an adjustable door stop 120 mounted on a hinge 140. As shown in FIG. 9, the adjustable door stop 120 is in one of a plurality of adjustment positions (90°) to limit the amount of door swing of a door 190 relative to a door frame 200 in which the door 190 is hung. In the illustrated embodiment, the adjustable door stop 120 is mounted on the hinge 140 and the modified hinge pin 150 is fully disposed within the recess 130 of the top portion 20. The first leg 30 of the first door stop member 10 is set so that the first leg 30 engages a first hinge leaf 170 of the hinge 140. The second leg 90 of the second door stop member 70 is set so that the second leg 90 engages with a hinge leaf 180 of the hinge 140. The relative positioning of the detents 50 of the male portion 40 and the apertures 110 of the female portion 80 will provide a relative spacing of the first leg 30 and the second leg 90 to allow a maximum of a 90° door swing.

In an example embodiment, the adjustable door stop 120 is rotatable about an axis formed by the modified hinge pin 150 with the relative positioning of the first stop member 10 and the second stop member 70 changing. Thus, when the door 190 is closed or moved from the 90° position, the door may swing freely yet be limited to the 90° swing position without resetting the relative positioning of the detents 50 of the male portion 40 relative to the apertures 110 in the female portion 80. Although the example embodiment shown in FIG. 9 illustrates a 90° limit position of the door 190 relative to the door frame or adjacent wall 200, one of skill in the art will appreciate that the due to the plurality of adjustment positions that may be effectuated by the relative positioning of the detents 50 of the male portion 40 and the apertures 110 of the female portion 80 to provide a variety of relative spacing's between the first leg 30 and the second leg 90, a variety of door swing limits may be achieved.

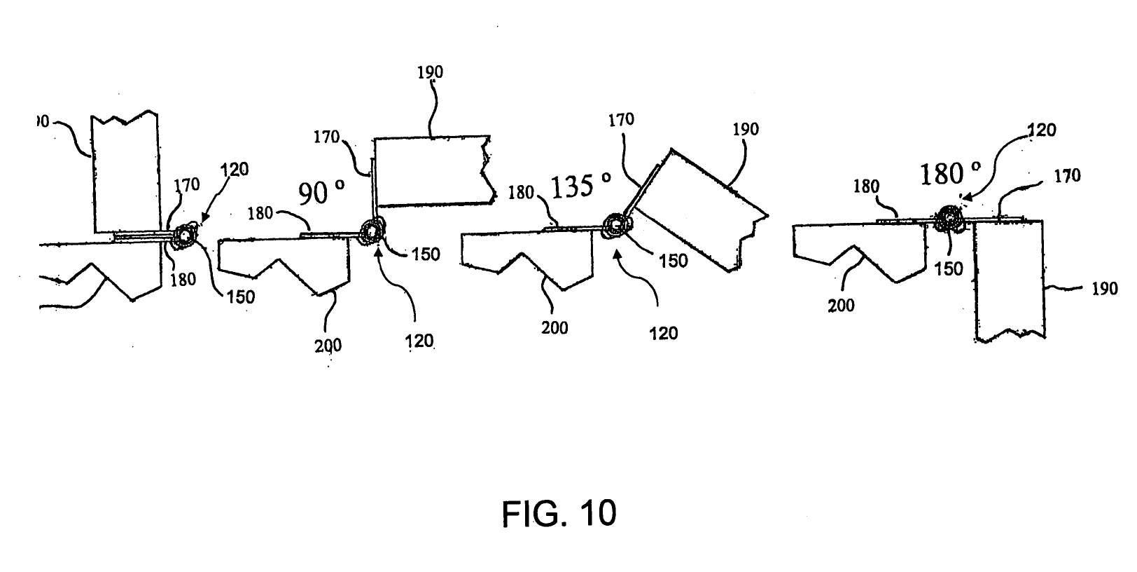

FIG. 10 shows a variety of stopped door positions in accordance with an example embodiment of the adjustable door stop 120. For example, in an exemplary and non-limiting embodiment, the adjustable door stop 120 may provide for relative positioning of hinge leafs 170, 180 (and concomitantly relative positioning of the door 190 and door frame/adjacent wall 200) of 90°, 135°, and 180°. Although positions of 90°, 135°, and 180° are illustrated in FIG. 10, such positions should not be considered limiting in either their degree of rotation or in the number of available positions. One of skill in the art will recognize that the degree of rotation and the number of available positions may be controlled according to the number of detents and/or the number of apertures in the adjustable door stop.

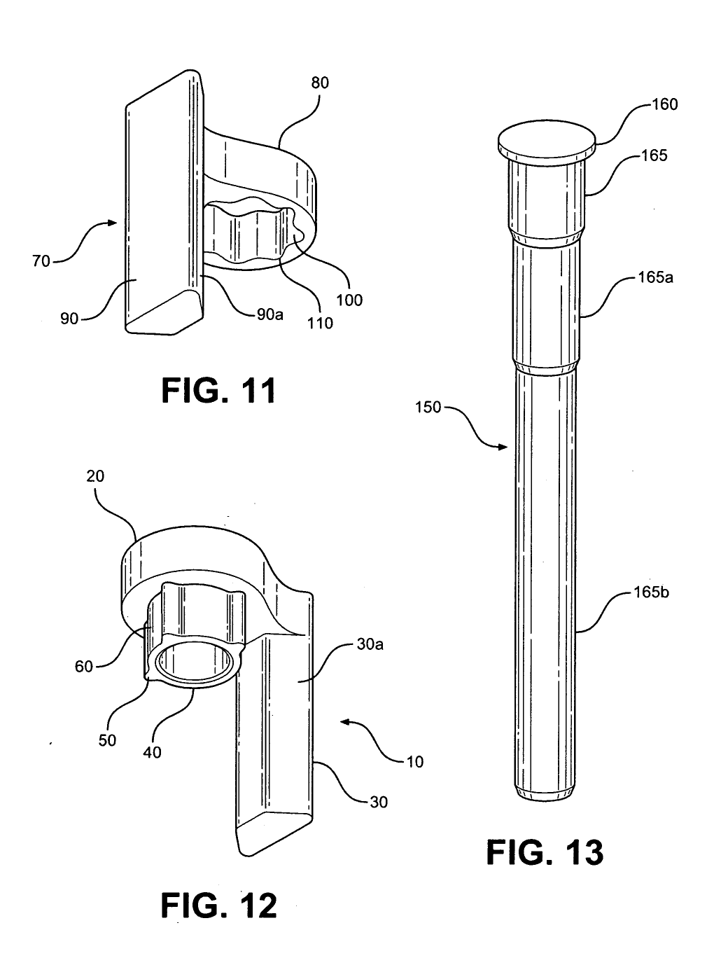

FIG. 11 shows an embodiment of a second door stop member 70 that includes a female portion 80 and a second leg 90 extending from the female portion 80 at essentially a right angle. The female portion 80 includes a hole formed by an interior side wall 100 that provides passage through the second door stop member 70 for a hinge pin as will be discussed in greater detail below. The interior side wall 100 includes a plurality of apertures 110 formed therein. The apertures 110 provide stop positions for the adjustable door stop 120 as will be discussed in greater detail below. As shown in FIG. 11, the second leg 90 has beveled or chamfered sides 90a which provide a greater surface area of contact between the second leg 90 and a respective hinge leaf, door or door stop which the second leg 90 may encounter thereby providing a greater distribution of forces encountered. The component parts of the second door stop member 70 (the female portion 80, the second leg 90) may be integrally formed from a single element by machining, casting, or the like, or formed of separate components and joined together by welding, brazing, gluing, or the like. In example embodiments, the component parts may be case hardened by heat treatment methods or cast using powdered metallurgy methods.

FIG. 12 shows an example embodiment of a first door stop member 10 that includes a top portion 20 and a first leg 30 extending from the top portion 20 at essentially a right angle. In an embodiment, a male portion 40 extends from the top portion 20 in the same direction as the first leg 30 and includes at least one detent 50 extending from the periphery of a wall 60 of the male portion 40. The detents 50 may be disposed at 45 degree intervals, or at larger or smaller angular relationships about the hole. In other embodiments, the male portion 40 and the first leg 30 may extend in opposing directions. A hole formed in part by the wall 60 passes through the male portion 40 and the top portion 20. The hole provides passage through the first door stop member 10 for a hinge pin as will be discussed in greater detail below. As shown in FIG. 12, the first leg 30 has beveled or chamfered sides 30a which provide a greater surface area of contact between the first leg 30 and a respective hinge leaf, door or door stop which the first leg 30 may encounter thereby providing a greater distribution of forces encountered. The component parts of the first door stop member 10 (top portion 20, the first leg 30, male portion 40) may be integrally formed from a single element by machining, casting, or the like, or formed of separate components and joined together by welding, brazing, gluing, or the like. In example embodiments, the component parts may be case hardened by heat treatment methods or cast using powdered metallurgy methods.

An example embodiment of a modified hinge pin 150 (FIG. 13) may include a head 160, a shaft portion 165a, and an expanded shaft portion 165 having a diameter greater than that of the shaft portion 165a. In the illustrated embodiment, the expanded portion 165 is located directly adjacent to and/or abutting the head 160. The modified hinge pin 150 may also have a length greater than a conventional hinge pin and/or greater than the original hinge pin of the hinge in which the adjustable door stop 120 is to be placed. In an example embodiment, the length of the modified hinge pin 150 is substantially equal to a conventional hinge pin plus the thickness of the top portion 20 and the female portion 80 (thickness being considered as the dimension in the axial direction of the hinge pin).

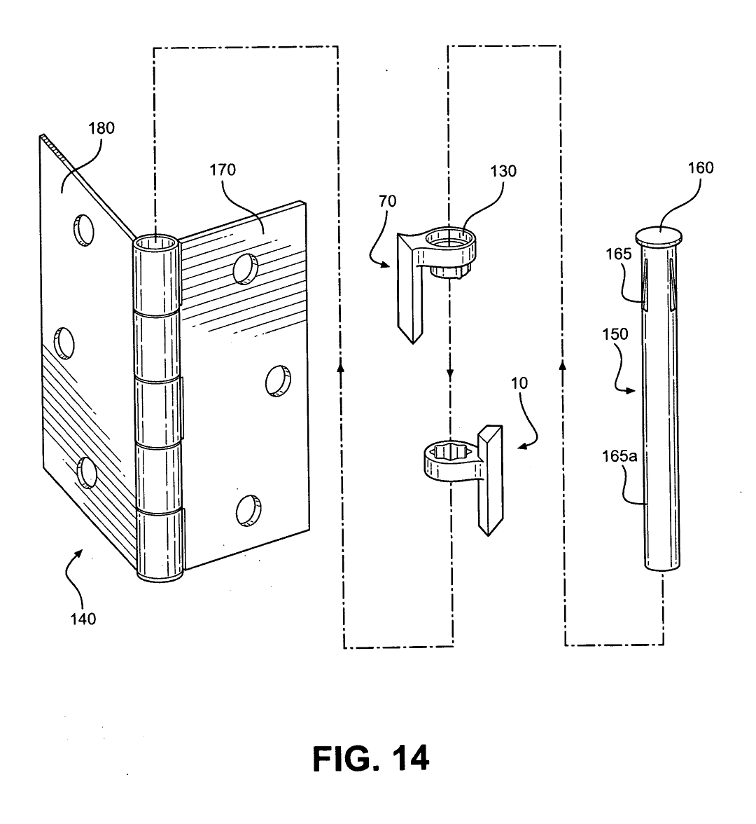

One of skill in the art would recognize that the modified hinge pin 150 is not limited to that shown in FIG. 13. For example, the expanded portion 165 may be tapered. Further, as shown in an embodiment in FIG. 14, the expanded portion may not be formed as a collar as in FIG. 13, but rather may consist of a series of spaced apart expanded portions (which may or may not be beveled/tapered) without departing from the scope of the present invention.

FIG. 14 shows an exploded view of an embodiment of the adjustable door stop 120 and an example embodiment of a hinge pin 150 with a hinge 140. As shown in FIG. 14, the male portion 40 of the first door stop member 10 is received in the female portion 80 of the second door stop member 70 such that the female portion 80 abuts against the top portion 20. As will be readily apparent to those of skill in the art, the adjustable door stop 120 is adjustable by varying the relative positioning of the first and second door stop members 10, 70 according to an alignment of the detents 50 on the male portion 40 with the apertures 110 of the female portion 80. When assembled, the first leg 30 and the second leg 90 are coextensive. By varying the relative positioning of the first and second door stop members 10, 70, the adjustable door stop 120 may be positioned to control the range of motion associated with the opening and closing of a door within a range of up to 360 degrees and/or the maximum movable range of a door hinge.

The modified hinge pin 150 includes a head 160, a shaft portion 165a, and an expanded shaft portion 165 having a diameter greater than that of the shaft portion 165a. In the illustrated embodiment, the expanded portion 165 is located directly adjacent to and/or abutting the head 160. The modified hinge pin 150 may also have a length greater than a conventional hinge pin and/or greater than the original hinge pin of the hinge in which the adjustable door stop 120 is to be placed. In an example embodiment, the length of the modified hinge pin 150 is substantially equal to a conventional hinge pin plus the thickness of the top portion 20 and the female portion 80 (thickness being considered as the dimension in the axial direction of the hinge pin).

In an example embodiment of the modified hinge pin 150, the expanded shaft portion 165 provides a tight fit in the adjustable door stop 120 and/or in a hinge 140 in which the adjustable door stop 120 is to be placed thereby deterring creep or lift of the modified hinge pin 150 out of the adjustable door stop 120 and/or hinge. Also, by having a shaft portion 165 of greater length than a conventional hinge pin, the hinge plates 170, 180 may be more securely maintained in their respective positions because the modified hinge pin will engage the entire length of the hinge. In contrast, if a conventional or original hinge pin were engaged with the adjustable door stop 120 and reinserted in a hinge, it is possible that the shaft of the original hinge pin would not extend through the entire length of the hinge plates due to the dimensions of the thickness of the first door stop member 10 and the second door stop member 70.

As shown in FIG. 14 the door stop 120 may be mounted in a door hinge 140 by inserting the hinge pin 150 through holes formed in the knuckles on each hinge leaf 170, 180. In the embodiment, the door stop 120 includes the first door stop member 10 having a first top portion 20 and a first leg 30 extending from the first top portion 20 in a direction parallel to the axis of the hole in the hinge leaf knuckle. The first leg portion 30 is configured to encounter at least one of the hinge leaf and a door casing 200 when installed to limit the degree of door swing.

The second door stop member 70 includes a second top portion 80 and a second leg 90 extending from the second top portion in a direction in a direction parallel to the axis of the hole in the hinge leaf knuckle. The second leg portion 90 is also configured to encounter at least one of the hinge leaf and a door casing when installed to limit the degree of door swing.

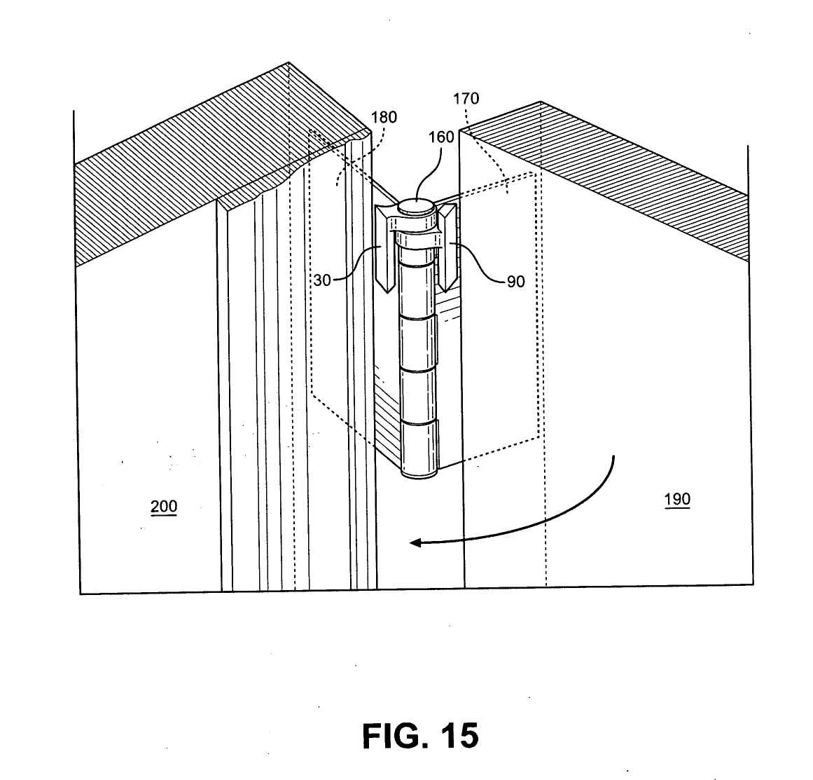

FIG. 15 shows an example embodiment of the adjustable door stop 120 on a hinge 140 with the modified hinge pin 150 inserted in the adjustable door stop 120. In an exemplary embodiment of the adjustable door stop 120, once the first door stop member 10 and the second door stop member 70 are positioned in a desired position on a conventional door hinge 140 by removing the hinge pin, the two primary components (positioned together) are placed on the top or bottom portion of the hinge 140 and inserting the modified hinge pin 150 through the corresponding holes in the assembled components. The two legs 30, 90 may engage respective sides of the hinge 140. In this embodiment, the beveled or chamfered portions 30a, 90a encounter respective hinge leafs 170, 180 to provide a meeting surface between the components that distributes forces due to opening the door over a larger area. The enlarged surface area of the legs 30, 90 provided by the beveled or chamfered portions 30, 90a strengthen the adjustable hinge assembly by distributing forces over a greater surface area.

As shown in FIG. 14, top portion 20 of the first door stop member 10 has a recess 130 formed therein allowing a head 160 of the modified hinge pin 150 to be positioned in the adjustable door stop 120 (see FIG. 15). Thus, the adjustable door stop 120 may be used by merely removing the original hinge pin from a hinge 140, positioning the adjustable door stop 120 and re-engaging the modified pin 150 through the adjustable door stop 120 and into the hinge 140.

As will be noted by one of skill in the art, the first leg 30 and the second leg 90 are circumferentially offset from one another. For example, the first and second legs 30, 90 may be rotationally spaced apart to adjustably limit the degree of door swing when installed. In example embodiments, the first and second door stop members 10, 70 may be adjustably rotated to a desired position as discussed above. In another embodiment, the first and second door stop members 10, 70 may be in a fixed, non-adjustable position relative to one another without departing from the scope of the present invention.

The above detailed description describes example embodiments of the present invention. Persons skilled in the art will recognize that alternative embodiments are possible without departing from the scope and spirit of the present invention. The above detailed description describes different embodiments of the present invention. For example, the illustrated embodiments of the adjustable door stop discussed herein may be made of a variety of materials including metals, plastics, ceramics, composites, and the like, without departing from the scope and intent of this invention.

What is claimed is:

1. An adjustable door stop, comprising:
a first door stop member including a first adjustment portion;
a second door stop member including a second adjustment portion configured to receive the first adjustment portion therein, the first door stop member and the second door stop member being relatively positionable via a position of the first adjustment portion relative to the second adjustment portion; and
a hinge pin having a shaft and a head extending radially from a first end of the shaft, the hinge being insertable into the adjustable door stop and into a door hinge, wherein
at least one of the first door stop member, the second door stop member and the hinge pin has an expanded portion configured to be inserted into the door hinge and having a diameter larger than a diameter of the shaft of the hinge pin.

2. The adjustable door stop of claim 1, wherein the hinge pin has the expanded portion and the expanded portion is adjacent to the head at the first end of the shaft, the expanded portion having a diameter smaller than the head and a diameter greater than that of the shaft.

3. The adjustable door stop of claim 1, wherein the first door stop member includes a hole formed through the first adjustment portion to receive the hinge pin and the second door stop member includes a hole formed therethrough to receive the hinge pin.

4. The adjustable door stop of claim 1, wherein the first adjustment portion comprises a substantially annular body having a smooth inner wall and at least one detent on an exterior surface of the body.

5. The adjustable door stop of claim 1, wherein the first adjustment portion includes a top portion and a substantially annular body with at least one detent formed on an exterior surface of the body, on the top portion.

6. The adjustable door stop of claim 3, wherein the first adjustment portion further includes a first leg extending from the top in a direction parallel to the axis of the hole in the first and second adjustment portions.

7. The adjustable door stop of claim 3, wherein the second adjustment portion includes an interior wall forming the hole through the second adjustment portion and a plurality of apertures formed on the interior wall.

8. The adjustable door stop of claim 7, wherein the plurality of apertures are configured to be in contact with the at least one detent.

9. The adjustable door stop of claim 3, wherein the second door stop member includes a second leg extending from the second adjustment portion in a direction parallel to the axis of the hole in the first and second adjustment portions.

10. The adjustable door stop of claim 3, wherein the top portion further includes a recess in a surface of the top portion and the hole in the first adjustment portion passes through the recess.

11. The adjustable door stop of claim 7, wherein the first door stop member and the second door stop member are relatively positionable via a positional relationship between the apertures of the second adjustment portion and at least one detent formed on the first adjustment portion.

12. The adjustable door stop of claim 1, wherein the first door stop member includes a first leg configured to engage with a hinge and the second door stop member includes a second leg configured to engage with the hinge.

13. An adjustable door stop for a hinge mounted door having at least one hinge leaf connected to the door and a hinge pin passing through the hinge, the adjustable door stop comprising:
a first door stop member including a top portion and a first adjustment portion extending from the top, and a first leg extending from the top in a direction parallel to the axis of the hinge pin to engage the hinge leaf and limit door swing;
a second door stop member including a second adjustment portion, the second adjustment portion configured to receive the first adjustment portion therein, and a second leg extending from the second adjustment portion in a direction parallel to the axis of the hinge pin to engage the hinge leaf and limit door swing, the first door stop member and the second door stop member being relatively positionable via a position of the first adjustment portion relative to the second adjustment portion; and
a hinge pin having a shaft and a head extending radially from a first end of the shaft, the hinge pin being insertable into the adjustable door stop and into the at least one hinge leaf, wherein
at least one of the first door stop member, the second door stop member and the hinge pin has an expanded portion configured to be inserted into the at least one hinge leaf and having a diameter larger than a diameter of the shaft of the hinge pin.

14. The adjustable door stop of claim 13, wherein the hinge pin has the expanded portion, the expanded portion being smaller than a diameter of the head and a diameter greater than that of the shaft.

15. The adjustable door stop of claim 13, wherein the first door stop member includes a hole formed through the first adjustment portion to receive the hinge pin and the second door stop member includes a hole formed therethrough to receive the hinge pin

16. The adjustable door stop of claim 13, wherein the first adjustment portion comprises a substantially annular body having a smooth inner wall and at least one detent on an exterior surface of the body.

17. The adjustable door stop of claim 15, wherein the second adjustment portion includes an interior wall forming the hole through the second adjustment portion and a plurality of apertures formed on the interior wall.

18. The adjustable door stop of claim 17, wherein the plurality of apertures are in contact with the at least one detent.

19. The adjustable door stop of claim 13, wherein the top portion further includes a recess in a surface of the top portion and the hole in the first adjustment portion passes through the recess.

20. The adjustable door stop of claim 18, wherein the first door stop member and the second door stop member are relatively positionable via a positional relationship between the apertures of the second adjustment portion and at least one detent formed on the first adjustment portion.

21. A door stop for a hinge mounted door having at least one hinge leaf connected to the door and a hole in the hinge leaf that receives a hinge pin passing through the hinge, the door stop comprising:
a first door stop member having a first top portion and a first leg extending from the first top portion in a direction parallel to the axis of the hole in the hinge leaf, the first leg portion being configured to encounter at least one of the hinge leaf and a door casing;
a second door stop member having a second top portion and a second leg extending from the second top portion in a direction parallel to the axis of the hole in the hinge leaf, the second leg portion being configured to encounter at least one of the hinge leaf and a door casing; and
a hinge pin integrally formed on and extending from one of the first door stop member and the second door stop member, the hinge pin being insertable into the hole in the hinge leaf, wherein
the hinge pin has an expanded portion having a diameter larger than a diameter of the hole in the hinge leaf, and
the first leg and the second leg are circumferentially offset from one another.

22. The door stop of claim 21, wherein the first door stop member and the second door stop member are relatively positionable to one another.

23. The door stop of claim 21, wherein the first door stop member and the second door stop member are in a fixed position relative to one another.

24. The adjustable door stop of claim 6, wherein the first leg includes a chamfered sidewall extending the length of the leg.

25. The adjustable door stop of claim 9, wherein the second leg includes a chamfered sidewall extending the length of the leg.

26. The adjustable door stop of claim 12, wherein the first leg and the second leg each include at least one chamfered sidewall extending the length of the leg.
